(19) United States
(12) Patent Application Publication
(10) Pub. No.: US 2015/0039223 A1
(43) Pub. Date: Feb. 5, 2015

(54) NAVIGATION DEVICE AND SERVER DEVICE

(71) Applicants: Tomoya Ikeuchi, Tokyo (JP); Kosei Uchino, Tokyo (JP); Hisanobu Masuda, Tokyo (JP)

(72) Inventors: Tomoya Ikeuchi, Tokyo (JP); Kosei Uchino, Tokyo (JP); Hisanobu Masuda, Tokyo (JP)

(21) Appl. No.: 14/379,903

(22) PCT Filed: Feb. 28, 2012
(86) PCT No.: PCT/JP2012/054850

§ 371 Date: Aug. 20, 2014

(51) Int. Cl. G01C 21/36; H04L 29/08

(52) U.S. Cl. CPC G01C 21/36; H04L 67/22
USPC 701/461; 701/409

(57) ABSTRACT

An object of the present invention is to provide a navigation device and a server device that are able to calculate an optimal route reflecting the user's intention in a case where a new site is added after a route to a destination is set. The navigation device of the present invention includes a route calculation unit. The route calculation unit is configured such that, in a case where the predetermined site is newly designated and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route.

### TECHNICAL FIELD

The present invention relates to a navigation device for people, vehicles, railway vehicles, ships, aircrafts, and the like, and particularly a navigation device suitable for carry-in or installation on a vehicle, and also relates to a server device that cooperates with the navigation device.

### BACKGROUND ART

Some of the conventional navigation devices are configured such that, when a new site is added after a route to a destination is set, the new site can be registered as a new destination instead of the already set destination, and the destination that has been set until then is set as a via point on the way to the new destination (for example, see Patent Document 1).

Some of the conventional navigation devices are also configured such that a plurality of routes from a designated departure site to a destination site via a plurality of via points are calculated with different passing orders (traveling orders) of passing through the via points, and one of the plurality of routes that provides the shortest distance or the shortest time is selected (for example, see Patent Document 2).

### PRIOR-ART DOCUMENTS

### Patent Documents

Patent Document 1: Japanese Patent Application Laid-Open NO. 2000-337910

Patent Document 2: Japanese Patent Application Laid-Open NO. 11-94578 (1999)

### SUMMARY OF THE INVENTION

### Problems to be Solved by the Invention

In the Patent Document 1, however, the already set traveling order of traveling the via points and the destination is not changed though a new destination is added. This makes it impossible to calculate the optimal route in a case where, when a new destination is added, the optimal route cannot be calculated without a change in the order of traveling via points.

In the Patent Document 2, when a new via point is added, the traveling order including the added via point is changed, so that the optimal route is calculated. Therefore, in a case where a new site is added after a route to the destination is set, it is impossible that the traveling order including the via points and the destination that has been already set is partially reflected to (maintained in) a newly calculated route, even though a user desires to do so. Thus, the optimal route that reflects the user's intention cannot be calculated.

The present invention has been accomplished to solve the problems described above, and an object of the present invention is to provide a navigation device and a server device that are able to calculate the optimal route reflecting the user's intention in a case where a new site is added after a route to the destination is set.

### Means for Solving the Problems

To solve the above-described problems, a navigation device of the present invention includes: a map information storage that stores map information; a sensor information input unit that inputs sensor information from at least one sensor, for identification of a current position of the navigation device; a current position specification unit that specifies the current position of the navigation device on a map based on the map information stored in the map information storage and the sensor information inputted to the sensor information input unit; a site input unit that inputs a predetermined site including a destination or a via point; and a route calculation unit that calculates a route from the current position specified by the current position specification unit to the predetermined site inputted to the site input unit. The route calculation unit is configured such that, in a case where the predetermined site is newly designated and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route.

The server device of the present invention includes: a map information storage that stores map information; a terminal information receiver that receives terminal-related information relating to an external terminal, the terminal-related information including sensor information for specification of a current position of the terminal obtained by the terminal and predetermined site information including a destination or a via point set by the terminal; a current position specification unit that specifies a current position of the terminal on a map based on the map information stored in the map information storage and the sensor information received by the terminal information receiver; a route calculation unit that calculates a route from the current position specified by the current position specification unit to the predetermined site received by the terminal information receiver; and an output unit that outputs, to the terminal, the route calculated by the route calculation unit. The route calculation unit is configured such that, in a case where the predetermined site information is newly received and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route.

A server device of the present invention includes: a terminal information receiver that receives terminal-related information relating to an external terminal, the terminal-related information including information of a current position of the terminal and predetermined site information including a destination or a via point set by the terminal; a route calculation unit that calculates a route from the current position to the predetermined site that are received by the terminal information receiver; and an output unit that outputs, to the terminal, the route calculated by the route calculation unit. The route calculation unit is configured such that, in a case where the predetermined site is newly received and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route.

### Effects of the Invention

In the present invention, a navigation device includes: a map information storage unit that stores map information; a sensor information input unit that inputs sensor information from at least one sensor, for identification of a current position of the navigation device; a current position specification unit that specifies the current position of the navigation device on a map based on the map information stored in the map information storage and the sensor information inputted to the sensor information input unit; a site input unit that inputs a predetermined site including a destination or a via point; and a route calculation unit that calculates a route from the current position specified by the current position specification unit to the predetermined site inputted to the site input unit. The route calculation unit is configured such that, in a case where the predetermined site is newly designated and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route. This enables calculation of an optimal route reflecting the user's intention in a case where a new site is added after a route to a destination is set.

The server device includes: a map information storage that stores map information; a terminal information receiver that receives terminal-related information relating to an external terminal, the terminal-related information including sensor information for specification of a current position of the terminal obtained by the terminal and predetermined site information including a destination or a via point set by the terminal; a current position specification unit that specifies a current position of the terminal on a map based on the map information stored in the map information storage and the sensor information received by the terminal information receiver; a route calculation unit that calculates a route from the current position specified by the current position specification unit to the predetermined site received by the terminal information receiver; and an output unit that outputs, to the terminal, the route calculated by the route calculation unit. The route calculation unit is configured such that, in a case where the predetermined site information is newly received and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route. This enables calculation of an optimal route reflecting the user's intention in a case where a new site is added after a route to a destination is set.

The server device includes: a terminal information receiver that receives terminal-related information relating to an external terminal, the terminal-related information including information of a current position of the terminal and predetermined site information including a destination or a via point set by the terminal; a route calculation unit that calculates a route from the current position to the predetermined site that are received by the terminal information receiver; and an output unit that outputs, to the terminal, the route calculated by the route calculation unit. The route calculation unit is configured such that, in a case where the predetermined site is newly received and the route calculation unit needs to re-calculate a new route under a situation that an existing route to an existing destination has been already calculated, and in a case where a section that is divided by via points included in the existing route is also included in the new route, a predetermined calculation condition at a time of route calculation is also applied to the section of the new route, the predetermined calculation condition being applied to the section of the existing route, so that the calculation is performed in consideration of a change in a traveling order of traveling the existing destination or an existing via point included in the existing route. This enables calculation of an optimal route reflecting the user's intention in a case where a new site is added after a route to a destination is set.

### BRIEF DESCRIPTION OF THE DRAWINGS

FIG. 1 is a block diagram showing a configuration of a car navigation device according to an embodiment 1 of the present invention.

FIG. 2 is a diagram showing an operation of the car navigation device according to the embodiment 1 of the present invention.

FIG. 3 is a flowchart showing an operation of the car navigation device according to the embodiment 1 of the present invention.

FIG. 4 is a flowchart showing an operation of the car navigation device according to the embodiment 1 of the present invention.

FIG. 5 is a diagram showing an operation of the car navigation device according to the embodiment 1 of the present invention.

FIG. 6 is a diagram showing an operation of the car navigation device according to the embodiment 1 of the present invention.

FIG. 7 is a diagram showing an operation of the car navigation device according to the embodiment 1 of the present invention.

FIG. 8 is a flowchart showing an operation of the car navigation device according to the embodiment 1 of the present invention.

FIG. 9 is a block diagram showing a configuration of a car navigation device according to an embodiment 2 of the present invention.

FIG. 10 is a flowchart showing an operation of the car navigation device according to the embodiment 2 of the present invention.

FIG. 11 is a flowchart showing an operation of a car navigation device according to an embodiment 3 of the present invention.

FIG. 12 is a diagram showing an operation of the car navigation device according to the embodiment 3 of the present invention.

FIG. 13 is a flowchart showing an operation of a car navigation device according to an embodiment 4 of the present invention.

FIG. 14 is a diagram showing an operation of the car navigation device according to the embodiment 4 of the present invention.

FIG. 15 is a block diagram showing a configuration of a server device according to an embodiment 5 of the present invention.

### EMBODIMENT FOR CARRYING OUT THE INVENTION

Hereinafter, embodiments of the present invention will be described with reference to the drawings.

### Embodiment 1

Firstly, a configuration of a car navigation device according to an embodiment 1 will be described. Although the embodiment 1 illustrates a car navigation device 1 for use in a vehicle as an example of the navigation device, the navigation device may be any navigation device for mobile objects such as people, vehicles, railway vehicles, ships, and aircrafts, and may be, for example, a Personal Navigation Device (PND) including a portable terminal.

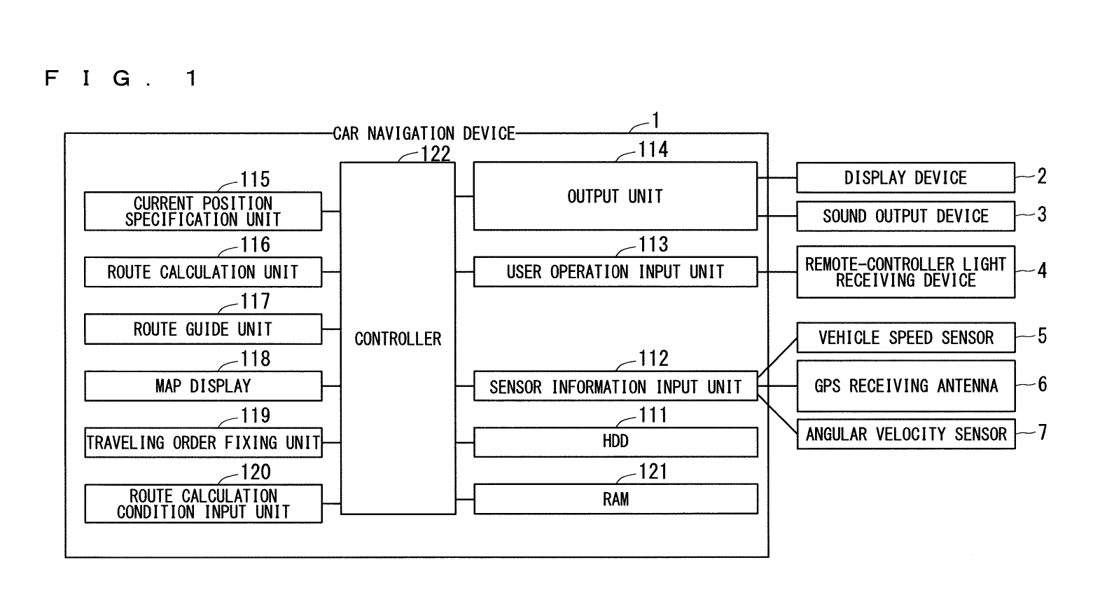

FIG. 1 is a block diagram showing a configuration of the car navigation device 1 according to the embodiment 1 of the present invention.

As shown in FIG. 1, the car navigation device 1 according to the embodiment 1 includes a Hard Disk Drive (HDD) 111 (map information storage means) that stores map information therein; a sensor information input unit 112 (sensor information input means) that inputs information (sensor information) from various sensors that are used for obtaining the position of the car navigation device 1; a user operation input unit 113 that inputs an operation performed by a user; a current position specification unit 115 (current position specification means), based on a current position obtained by using the information inputted to the information input unit 112 and the map information stored in the HDD 111, calculate and specify the location on a road in a map where the current position of the car navigation device 1 is most likely to exist; a route calculation unit 116 (route calculation means) that calculates an optimal route from the current position to a predetermined site or an optimal route between predetermined sites (hereinafter, also referred to simply as an optimal route); a route calculation condition input unit 120 (route calculation condition input means) that receives input of a predetermined calculation condition that is applied when the route calculation unit 116 calculates a route; a route guide unit 117 that provides a route guidance such as indication of left and right turns in accordance with the optimal route calculated by the route calculation unit 116; a map display 118 configured to generate a map image of a place around the current position or a predetermined site, which is displayed on the display device 2 via the output unit 114; an output unit 114 that outputs results of various processing to the display device 2 and a sound output device 3; a RAM 121; and a controller 122 that totally controls operations of elements of the car navigation device 1.

The display device 2, the sound output device 3, a remote-controller light receiving device 4, a vehicle speed sensor 5, a GPS receiving antenna 6, and an angular velocity sensor 7 are connected to the car navigation device 1. The display device 2 displays information of the map image and the optimal route that is outputted from the output unit 114. The sound output device 3 outputs, in the form of sounds, a sound guidance of a path to the destination along the optimal route, information included in the map information, and the like. The remote-controller light receiving device 4 receives an user's operation performed with a wireless remote controller. The vehicle speed sensor 5 measures the speed of a vehicle having the car navigation device 1 installed therein. The GPS receiving antenna 6 receives a signal from a GPS satellite. The angular velocity sensor 7 measures a change in the direction of the car navigation device 1. To be specific, the display device 2 and the sound output device 3 are connected to the output unit 114, the remote-controller light receiving device 4 is connected to the user operation input unit 113, and the vehicle speed sensor 5, GPS receiving antenna 6, and the angular velocity sensor 7 are connected to the sensor information input unit 112.

Each element of the car navigation device 1 achieves its own function by reading and writing necessary information from and to the RAM 121.

The map information stored in the HDD 111 is expressed in a graph structure in which an intersection is represented by a node and a road between intersections is represented by a link. For each link, information including cost information necessary for passing through a road corresponding to the link, a travel distance for the link, whether or not it is a toll road, and the like, is set.

By using the cost information set for each link included in the map information, the route calculation unit 116 calculates, as the optimal route, a route that provides the minimum accumulated cost by means of a known search method (for example, Dijkstra's algorithm).

The user operation input unit 113 also functions as a site input means to which the user inputs a destination and a via point. In a case where the user inputs not only a destination but also via points, the route calculation unit 116 divides the route at the via points into sections, calculates the optimal route for each divided section by means of the above-mentioned search method, and connects (joins) the sections for which the optimal routes have been calculated to one another, thereby obtaining the optimal route to the destination.

For calculating the optimal route in each section, the route calculation unit 116 can select any one condition from a plurality of predetermined search conditions prepared in advance, and adjust the cost for each link based on the selected search condition. For example, three search conditions of “recommended mode”, “toll-road avoiding mode”, and “distance priority mode” are prepared. In a case where the “recommended mode” is selected, only the cost information set for the link is used to calculate the optimal route. In a case where the “toll-road avoiding mode” is selected, the optimal route is calculated with a predetermined penalty cost being added to the cost information of the link for which a toll road is set, based on the information set for the link indicating whether or not the road is a toll road. In a case where the “distance priority mode” is selected, the optimal route is calculated based on the travel distance for the link instead of the cost information.

The route calculation condition input unit 120 (route calculation condition input means) functions as a part for receiving an input of the search condition described above. The user can select a desired search condition (predetermined calculation condition) from predetermined search conditions prepared in advance, and input it through the user operation input unit 113. The selected search condition can be applied to the entire route from the current location to the destination or to each section divided at the via points.

The car navigation device 1 includes a traveling order fixing unit 119 (traveling order fixing means). The traveling order fixing unit 119 fixes the absolute traveling order of traveling predetermined via points and the destination among the destination and the via points included in the current route (existing route).

Next, the via point, which is one of features of the car navigation device 1 according to the embodiment 1, will be described.

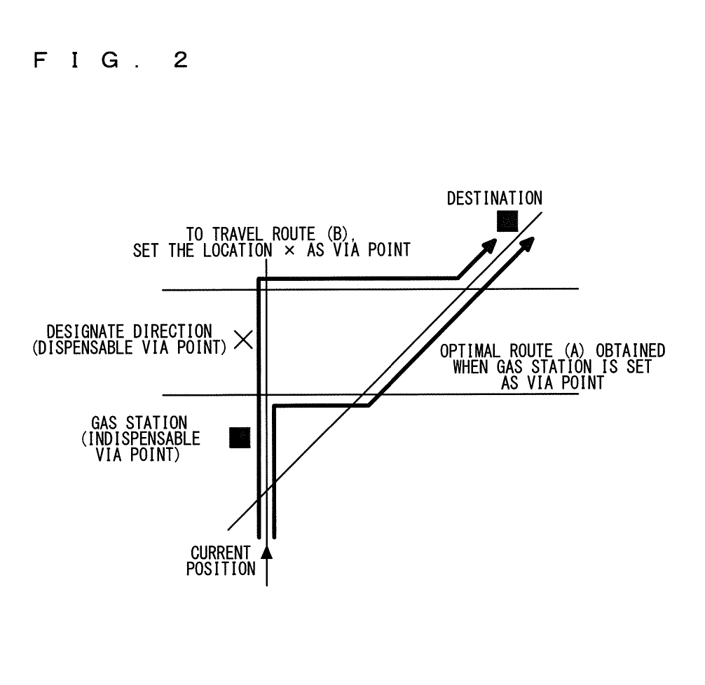

The car navigation device 1 classifies the via points inputted through the user operation input unit 113 into two types of an indispensable via point and a dispensable via point. As shown in FIG. 2, in a situation that there is the need to stop at a gas station on the way from the current position to the destination, the user sets the gas station as a via point, so that a route A including the gas station as a via point is calculated as the optimal route. In a case where the user desires to travel a route B instead of the route A, the user, for example, adds a via point to the location indicated by the mark x (designate the direction), and thereby the desired route B is obtained.

In the car navigation device according to the embodiment 1, as described above, a via point such as the gas station at which the user desires to stop without fail (at which stopping is indispensable) is classified into the indispensable via point, while a via point that is set for the purpose of obtaining a desired route and at which the user does not necessarily desire to stop (at which stopping is not indispensable) is classified into the dispensable via point. The classification of the via point is inputted by the user designating either of the indispensable via point and the dispensable via point when inputting the via point via the user operation input unit 113 (site input meas), for example. Alternatively, all of the via points inputted via the user operation input unit 113 are automatically registered as the indispensable via points, and the user changes some of the registered via points into the dispensable via point (designates the dispensable via point) if needed.

Next, an operation of the car navigation device 1 according to the embodiment 1 will be described.

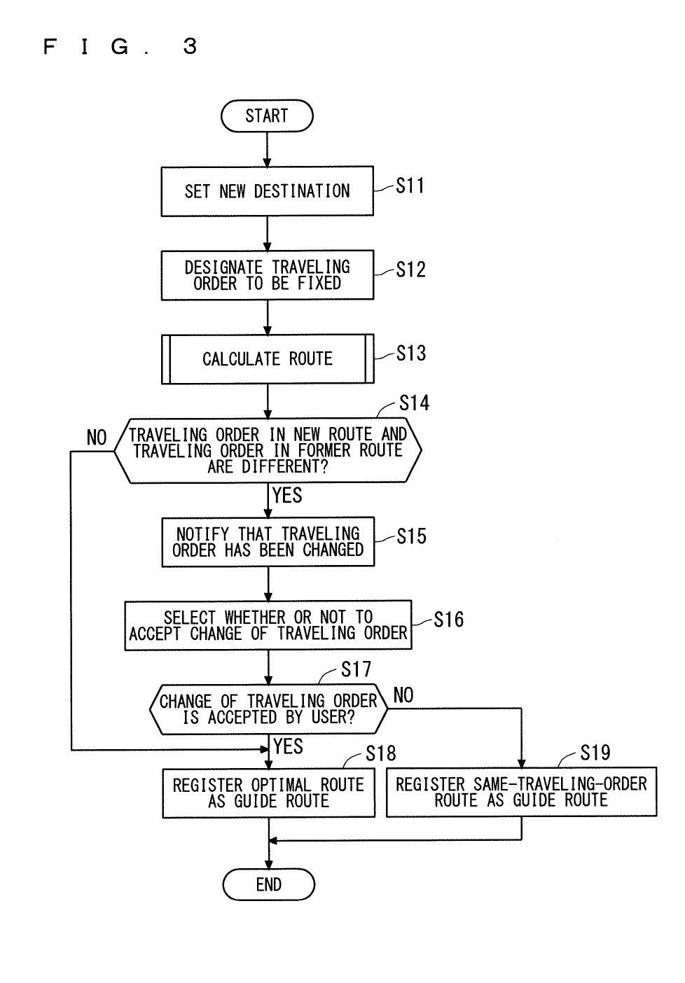

FIG. 3 is a flowchart showing an operation of the car navigation device 1 according to the embodiment 1. The operation shown in FIG. 3 is based on the precondition that the destination has been already set and a route (hereinafter also referred to as a current route) has been calculated. Additionally, it is assumed that when the destination of the current route is set or under a state where the current route has been calculated, the two types of via points (the indispensable via point and the dispensable via point) have been set by the user.

Under such a state, as shown in FIG. 3, when the need arises that the user set a new destination (hereinafter, also referred to as a new destination), the user sets a new destination via the user operation input unit 113 (step S11).

After the new destination is set in step S11, then the user designates, via the user operation input unit 113, a site whose traveling order should remain unchanged in a route to the new destination (hereinafter, also referred to as a new route) among the via points and the destination included in the current route (step S12). The traveling order designated by the user is set by the traveling order fixing unit 119. In a case where a site whose traveling order should remain unchanged in the new route does not exist, step S12 ends without any processing performed, and the processing moves to step S13.

Then, the route calculation unit 116 calculates the route based on the contents set in step S11 and step S12 (step S13). In step S13, the new route and a same-traveling-order route are calculated. The new route serves as the optimal route. The same-traveling-order route maintains the traveling order of traveling the indispensable via points and the former destination included in the current route. Details of the operation performed in step S13 will be described later.

Then, whether or not the traveling order of traveling the via points and the destination in the current route remains unchanged in the new route, too, is determined (step S14).

When it is determined in step S14 that the traveling order remains unchanged (step S14: NO), the new route that is the optimal route calculated in step S13 is set as a guide route (step S18), and then a series of processing (the process shown in FIG. 3) concerning setting of the new destination is terminated. Thus, the route guide unit 117 starts a route guidance in accordance with the new route (not shown).

On the other hand, when it is determined in step S14 that the traveling order is changed (step S14: YES), the output unit 114 outputs (notifies) that the traveling order in the current route and the traveling order in the new route are different (that the traveling order has been changed) (step S15).

Then, the user selects whether or not to accept the new route notified in step 15 via the user operation input unit 113 (step S16). To be specific, when the output unit 114 outputs that the traveling orders are different, the user operation input unit 113 presents a selectable option of whether the traveling order in the current route or the traveling order in the new route is to be applied for re-calculation of the new route. This allows the user to be aware of the new route including the changed traveling order. Additionally, enabling the selection of the route can reflect the user's intention not to change the traveling order.

Then, based on the result of selection in step S16, whether or not the change in the traveling order is accepted is determined (step S17).

When it is determined in step S17 that the change in the traveling order is accepted (step S17: YES), the new route that is the optimal route is set as the guide route (step S18), and then the series of processing (the process shown in FIG. 3) concerning setting of the new destination is terminated. Thus, the route guide unit 117 starts a route guidance in accordance with the new route (not shown).

On the other hand, when it is determined in step S17 that the traveling order is not accepted (step S17: NO), the same-traveling-order route calculated in step S13 is set as a guide route (step S19), and then the series of processing is terminated. Thus, the route guide unit 117 starts a route guidance in accordance with the guide route (not shown).

Next, details of the operation performed in step S13 shown in FIG. 3 will be described.

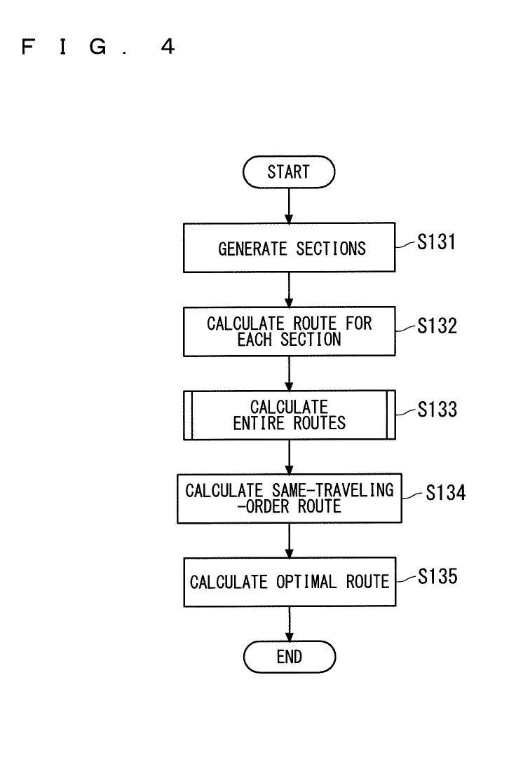

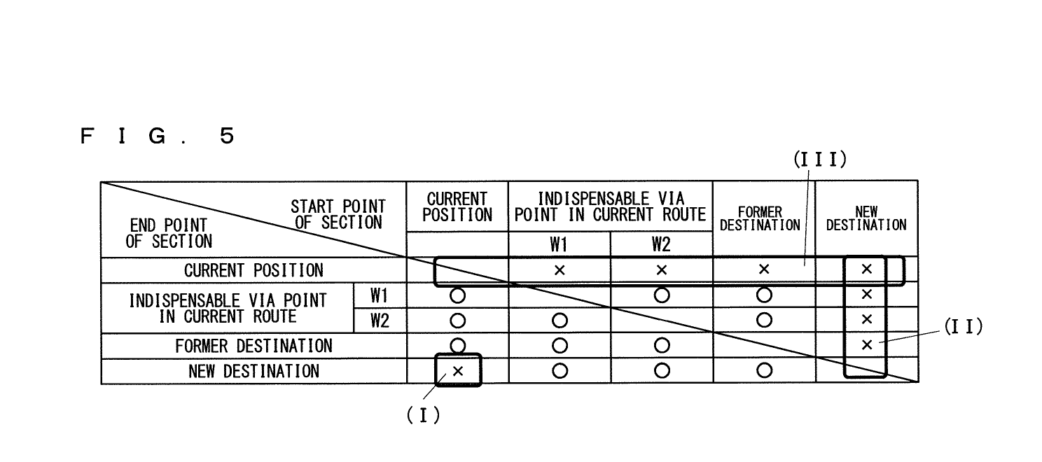

FIG. 4 is a flowchart showing details of the operation performed in step S13. FIGS. 5 to 7 are diagrams showing an example of the operation shown in FIG. 4.

As shown in FIG. 4, firstly, sections whose start and end points are the current position, the destination in the current route (hereinafter, also referred to as a former destination), the indispensable via point in the current route, and the new destination, are generated (step S131).

At this time, a section whose start point is the current position and whose end point is the new destination is not generated (FIG. 5-I). A section whose start point is the new destination is not generated, either (FIG. 5-II). A section whose end point is the current position is not generated, either (FIG. 5-III). Sections other than the aforementioned sections are generated (marked with circles in FIG. 5). FIG. 5 shows an example case where two indispensable via points of W1 and W2 are set in the current route.

After the generation of the section in step S131 is completed, the route is calculated for each of the generated sections (step S132).

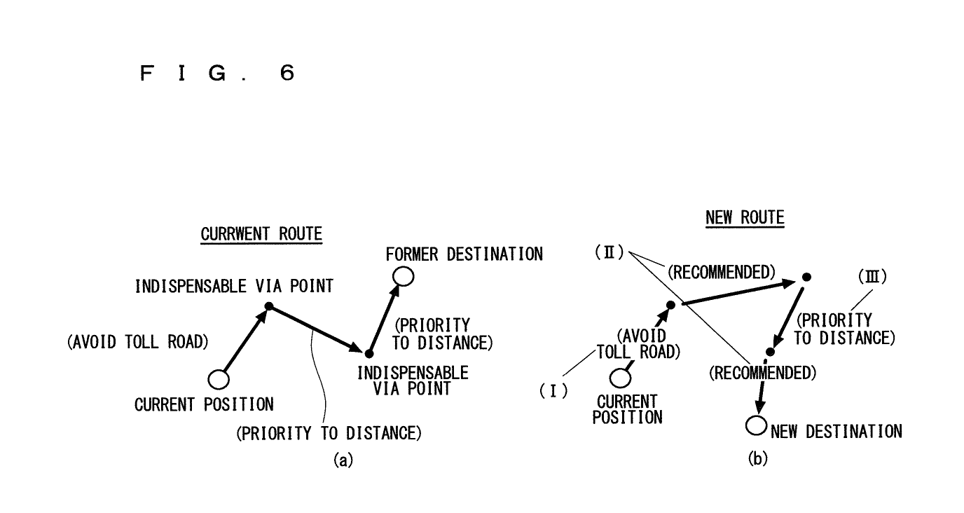

For example, referring to FIG. 6, in a case where the current route includes a section whose start point and end point are coincident with those of a section included in the new route, the search condition applied to this section of the current route is used. In the section shown in a portion (b)-I of FIG. 6, the “toll-road avoiding mode”, which is applied to the current route, is used as the search condition for this section as well. In a case where there is any section not included in the current route, a predetermined condition that has been programmed in advance is used. In the section shown in a portion (b)-II of FIG. 6, the “recommended mode” is used as the predetermined condition.

Thus, the route calculation unit 116 is configured such that, in re-calculation of the new route, in a case where a section included in the current route (existing route) is also included in the new route, the predetermined calculation condition applied to the section of the current route is also applied to the corresponding section of the new route, and in a case where a section included in the current route is not included in the new route, a predetermined calculation condition that has been specified in advance is applied to the section of the new route.

In a case where the current route includes a section whose start and end points are reversed (inverted), the search condition for the corresponding section of the current route is used. In the section shown in a portion (b)-III of FIG. 6, the “distance priority mode” which is applied to the corresponding section of the current route is used as the search condition for this section as well.

Thus, in a case where the current route includes a section that is divided at the same via points as the via points dividing a section included in the new route and that has a traveling order direction inverted from the traveling order direction of the corresponding section of the new route, the route calculation unit 116 applies, to this section, the same predetermined calculation condition as the predetermined calculation condition used for calculation of the current route.

In the determination of whether or not “the current route includes a section whose start and end points are coincident with those of a section included in the new route” or whether or not “the current route includes a section whose start and end points are reversed (inverted)”, the section of the current route is, with any dispensable via point being deleted, compared with the section of the new route.

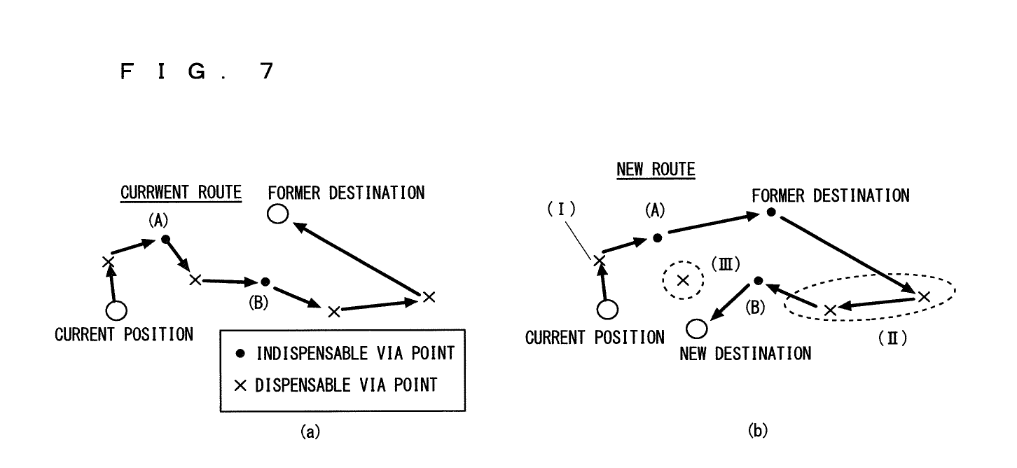

In addition, in a case where the current route includes a section whose start and end points are coincident with those of a section included in the new route, a route is calculated that extends from the start point of the section to the end point of the section through the dispensable via points in the same traveling order as the traveling order adopted in the corresponding section of the current route. For example, referring to FIG. 7, the route extending from the start point of a section to the end point of the section is calculated through the dispensable via point in the same traveling order as the traveling order adopted in the current route (a portion (b)-I of FIG. 7). This enables calculation of a route that reflects the user's intention by using the dispensable via point whose significance is not lost even when the traveling order of traveling the via points is changed.

In a case where the current route includes a section whose start and end points are reversed (inverted), a route is calculated that extends from the start point of the section to the end point of the section through the dispensable via points in a traveling order that is inverted from the traveling order adopted in the current route (a portion (b)-II of FIG. 7). In the portion (b)-II of FIG. 7, the route is calculated with the traveling order of traveling the dispensable via points is inverted from the traveling order adopted in the current route. However, the calculation of the route may be performed without using the dispensable via points. Alternatively, whether or not to use the dispensable via points may be selected by the user.

In a case where the new route does not include a section of the current route, the dispensable via points included in the section of the current route are not used for the calculation of the new route (a portion (b)-III of FIG. 7). This enables avoidance of the calculation of an inappropriate route, which may otherwise be caused by using the dispensable via point whose significance is lost when the traveling order of traveling the via points is changed.

Then, after the calculation of a route for each section in step S132 is completed, the calculated routes for the respective sections are connected so that entire routes extending from the current position to the new destination are calculated in all combinations (step S133). Details of the operation performed in step S133 will be described later.

Then, among the entire routes calculated in step S133, the entire route having the same traveling order of traveling the indispensable via point and the former destination as the traveling order adopted in the current route is determined and registered as the same-traveling-order route (step S134), and the route that provides the minimum total cost is selected as the optimal route (step S135). Then, the process is terminated.

Next, details of the operation performed in step S133 shown in FIG. 4 will be described.

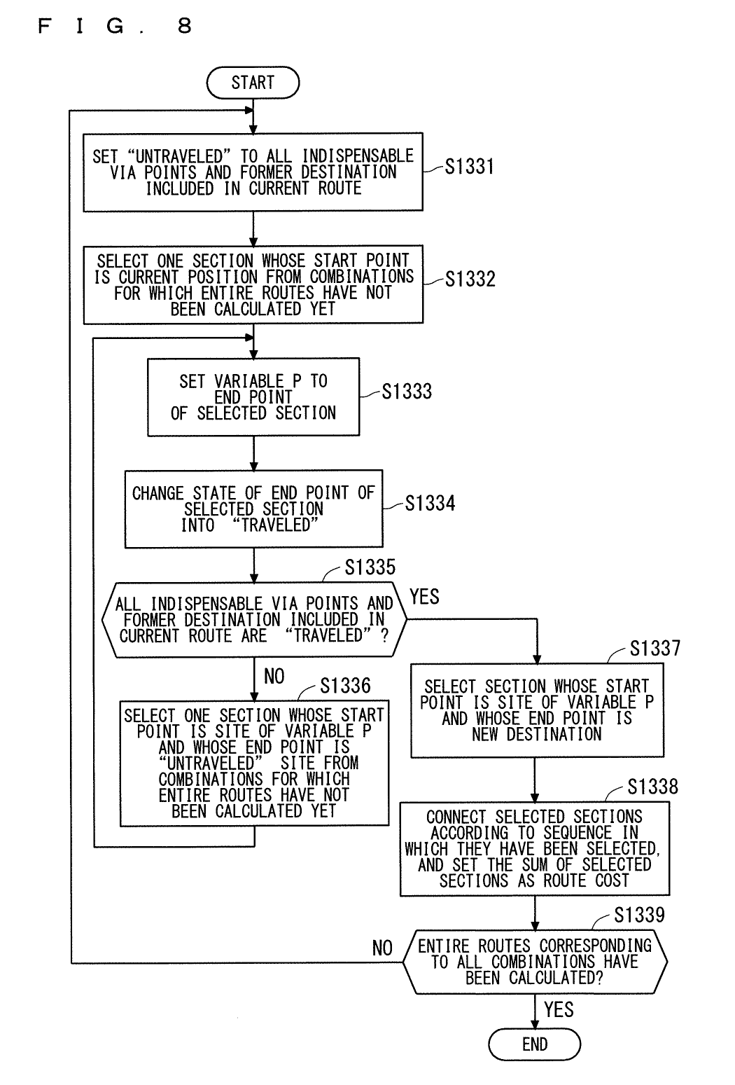

FIG. 8 is a flowchart showing details of the operation performed in step S133.

As shown in FIG. 8, firstly, the state of “untraveled” is set to all the indispensable via points and the former destination included in the current route (step S1331).

Then, among the sections whose start point is the current position, one section is selected as an end point, from the combinations for which the entire routes have not been calculated yet (step S1332).

Then, the end point of the section selected in step S1332 is set as a variable P (step S1333).

Then, the state of the end point of the selected section is changed from “untraveled” to “traveled” (step S1334).

Then, whether or not all the indispensable via points and the former destination included in the current route are “traveled” is determined (step S1335),

When it is determined in step S1335 that the state is not “traveled”, that is, an “untraveled” site remains (step S1335: NO); a section whose start point is the site of the variable P and whose end point is one of the “untraveled” sites is selected from the combinations for which the entire routes have not been calculated yet (step S1336). Then, the processing returns to step S1333.

On the other hand, it is determined in step S1335 that all are “traveled” (step S1335: YES), a section whose start point is the site of the variable P and whose end point is the new destination is selected (step S1337).

Then, all the selected sections are sequentially connected to build an entire route, and the sum of the selected sections is set as the cost of the entire route thus built (step S1338).

Then, whether or not the entire routes corresponding to all the combinations of the sections have been calculated is determined (step S1339). When it is determined that they have been calculated, the process is terminated (step S1339: YES). When it is determined that they have not been calculated yet (step S1339: NO), the processing returns to step S1331.

In the process shown in FIG. 8 described above, if there is any site whose traveling order has been fixed in step S12 of FIG. 3, the section selection processing in step S1332 and step S1336 or the processing in step S1339 is performed in consideration of the traveling order.

For example, in a case where the traveling order of traveling a certain indispensable via point is designated as the first order (that is, the certain indispensable via point is a site traveled immediately after the current position), a section whose end point is the indispensable via point is selected in step S1332. In a case where a traveling order of traveling a certain indispensable via point is designated as the second order, a section whose end point is the indispensable via point designated as the second order is selected in the first step S1336 of the process shown in FIG. 8. In step S1339, an entire route that could not be calculated because of the fixed traveling order is excluded from the determination.

In the embodiment 1, therefore, in a case where, under a situation that a new site (new destination) is added after a route to the destination is set, the user intends to designate the order of traveling a part of the via points and destination (existing via points and destination) included in the current route, optimization of the route is enabled with reflection of such an intention. Moreover, a search condition that the user has set for the calculation of the current route can be taken over in the calculation of the new route. Thus, the embodiment 1 is able to calculate an optimal route reflecting the user's intention.

In the embodiment 1, the user operation input unit 112 is connected to the remote-controller light receiving device 4 that receives a signal of the wireless remote controller, and receives an operation performed by the user. Instead, it may be acceptable that the display device 2 includes a touch panel and the user operation input unit 113 is connected to the display device 2. It may be also acceptable that the user operation input unit 113 is connected to an operation button (not shown) provided in the car navigation device 1.

### Embodiment 2

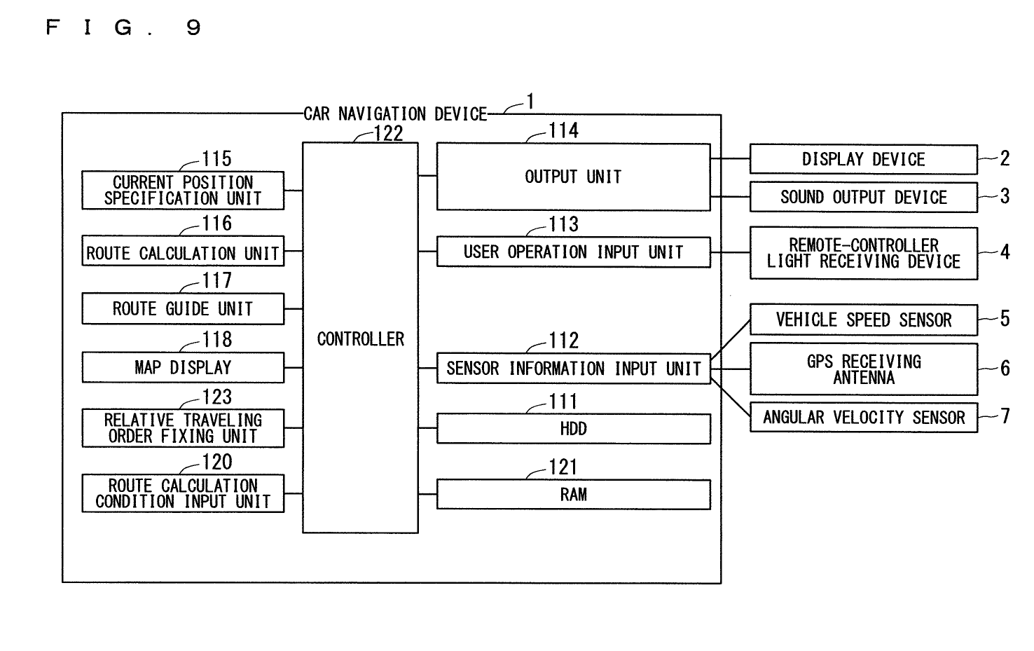

FIG. 9 is a block diagram showing a configuration of a car navigation device 1 according to an embodiment 2 of the present invention. As shown in FIG. 9, the car navigation device 1 according to the embodiment 2 is characterized in that a relative traveling order fixing unit 123 is provided instead of the traveling order fixing unit 119 included in the car navigation device 1 according to the embodiment 1.

The relative traveling order fixing unit 123 fixes a relative traveling order of a predetermined via point and the destination among the destination (existing destination) and the via points (existing via points) included in the current route (existing route). Similarly to the traveling order fixing unit 119 of the embodiment 1, the traveling order is designated (fixed) by the user via the user operation input unit 113. The route calculation unit 116 applies the traveling order fixed by the relative traveling order fixing unit 123 to the calculation of the new route. The other configurations and operations are the same as those of the embodiment 1, and therefore their descriptions are omitted herein.

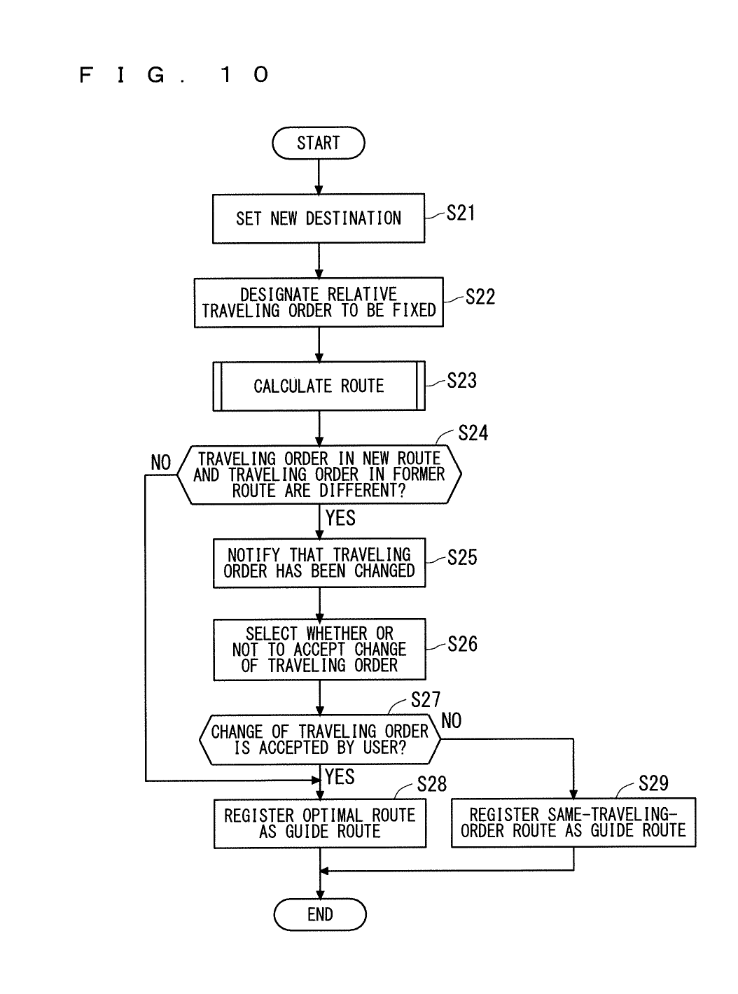

FIG. 10 is a flowchart showing an operation of the car navigation device 1 according to the embodiment 2.

As shown in FIG. 10, the car navigation device 1 according to the embodiment 2 is characterized by the processing of step S22. The other processing is the same as the processing of the embodiment 1. To be specific, step S21 of FIG. 10 corresponds to step S11 of FIG. 3. Step S23 to step S29 of FIG. 10 correspond to step S13 to step S19 of FIG. 3. In the following, a description will be given only to differences from the operation of the embodiment 1.

In step S22 of FIG. 10, at least two sites are designated from the indispensable via points and the former destination included in the current route. In a case where no site is designated, this processing is not performed.

Although the embodiment 1 considers the fixed traveling order in the section selection processing of steps S1332 and S1336 or in the processing of step S1339 of FIG. 8, the embodiment 2 considers a relative travel order if there is any site whose relative travel order is fixed (designated) in step S22. That is, in a case where a site whose relative traveling order is set to be an earlier order is “untraveled”, a section whose end point is a site having a later relative traveling order is not selected. In step S1339, an entire route that could not be calculated because of the fixed relative traveling order is excluded from the determination.

In the embodiment 2, therefore, in a case where, under a situation that a new site (new destination) is added after a route to the destination is set, the user intends to designate the order of traveling a part of the via points and destination (the existing via points and destination) included in the current route, optimization of the route is enabled with reflection of such an intention. Moreover, a search condition that the user has set for the calculation of the current route can be taken over in the calculation of the new route. Thus, the embodiment 2 is able to calculate an optimal route reflecting the user's intention.

### Embodiment 3

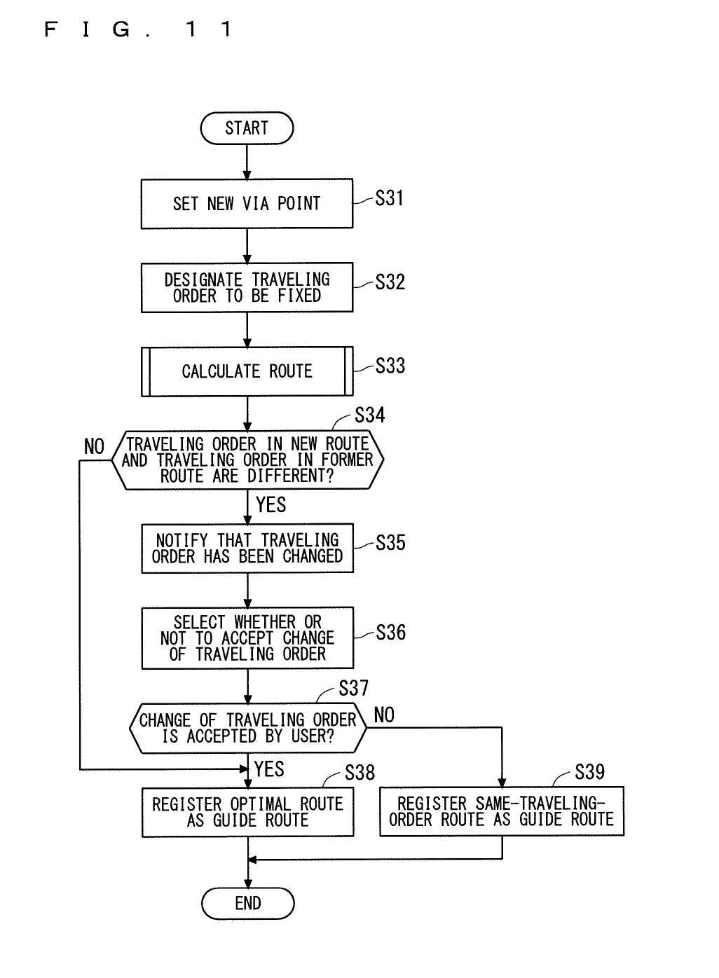

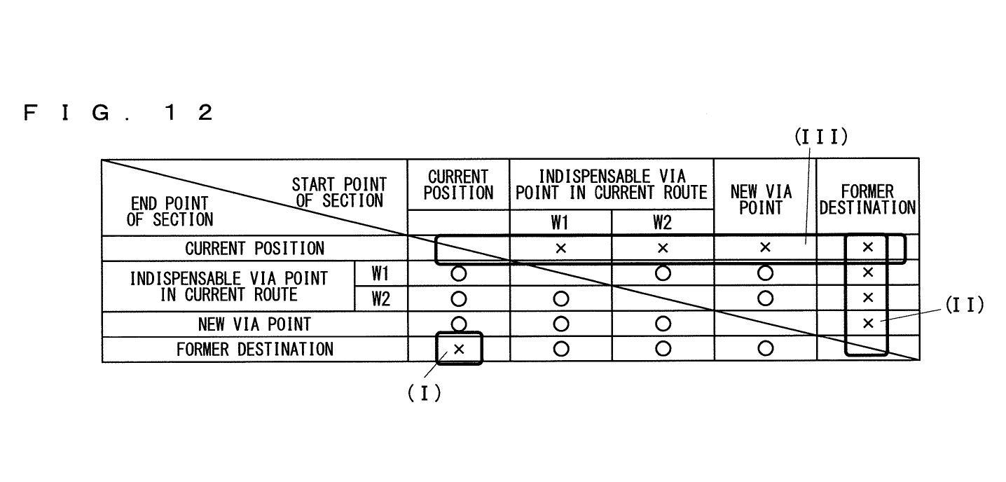

FIG. 11 is a flowchart showing an operation of a car navigation device 1 according to an embodiment 3. FIG. 12 is a diagram showing an operation of the car navigation device 1 according to the embodiment 3.

As shown in FIG. 11, the car navigation device 1 according to the embodiment 3 is characterized by the processing of step S31. The other processing is the same as the processing of the embodiment 1. Step S32 to step S39 of FIG. 11 correspond to step S12 to step S19 of FIG. 3. In the following, a description will be given only to differences from the operation of the embodiment 1. The configuration of the car navigation device 1 according to the embodiment 3 is the same as that of the embodiment 1, and therefore a description thereof is omitted herein.

In step S31 of FIG. 11, when the need to set a new via point arises in the user, the user sets a new via point via the user operation input unit 113. At this time, the destination remains unchanged from the destination (hereinafter, also referred to as a former destination) included in the current route.

In the embodiment 3, in the generation of sections in step S131 of FIG. 4, a section whose start point is the current position and whose end point is the former destination is not generated (FIG. 12-I). A section whose start point is the former destination is not generated (FIG. 12-II). A section whose end point is the current position is not generated (FIG. 12-III). Sections other than the aforementioned sections are generated (marked with circles in FIG. 12). FIG. 12 shows an example case where two indispensable via points of W1 and W2 are set in the current route.

Accordingly, in the embodiment 3, in a case where, under a situation that a new site (new via point) is added after a route to the destination is set, the user intends to designate the order of traveling a part of the via points and destination (the existing via point and destination) included in the current route, optimization of the route is enabled with reflection of such an intention. Moreover, a search condition that the user has set for the calculation of the current route can be taken over in the calculation of the new route. Thus, the embodiment 3 is able to calculate an optimal route reflecting the user's intention.

### Embodiment 4

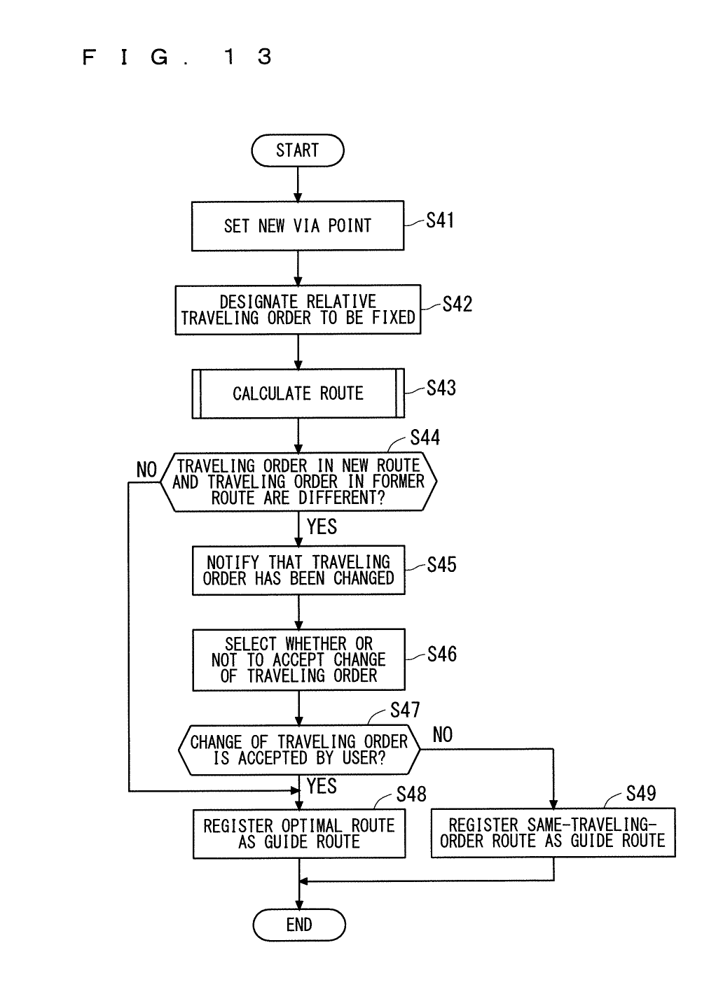

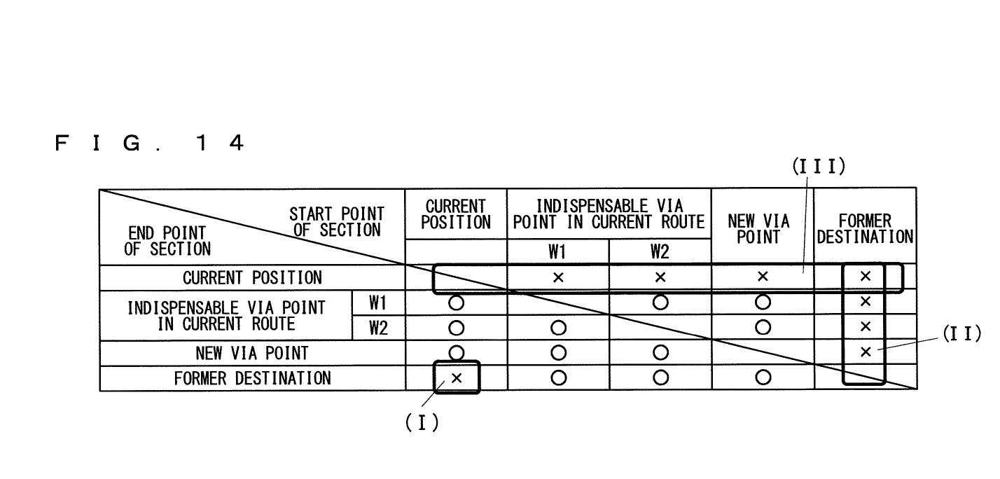

FIG. 13 is a flowchart showing an operation of a car navigation device 1 according to an embodiment 4. FIG. 14 is a diagram showing an operation of the car navigation device 1 according to the embodiment 4.

As shown in FIG. 13, the car navigation device 1 according to the embodiment 4 is characterized by the processing of step S41. The other processing is the same as the processing of the embodiment 2. Step S42 to step S49 of FIG. 13 correspond to step S22 to step S29 of FIG. 10. In the following, a description will be given only to differences from the operation of the embodiment 2. The configuration of the car navigation device 1 according to the embodiment 4 is the same as that of the embodiment 2, and therefore a description thereof is omitted herein.

In step S41 of FIG. 13, when the need to set a new via point arises in the user, the user sets a new via point via the user operation input unit 113. At this time, the destination remains unchanged from the destination (hereinafter, also referred to as a former destination) included in the current route.

In the embodiment 4, in the generation of sections in step S131 of FIG. 4, a section whose start point is the current position and whose end point is the former destination is not generated (FIG. 14-I). A section whose start point is the former destination is not generated (FIG. 14-II). A section whose end point is the current position is not generated (FIG. 14-III). Sections other than the aforementioned sections are generated (marked with circles in FIG. 14). FIG. 14 shows an example case where two indispensable via points of W1 and W2 are set in the current route.

In the embodiment 4, therefore, in a case where, under a situation that a new site (new via point) is added after a route to the destination is set, the user intends to designate the order of traveling a part of the via points and destination (the existing via point and destination) included in the current route, optimization of the route is enabled with reflection of such an intention. Moreover, a search condition that the user has set for the calculation of the current route can be taken over in the calculation of the new route. Thus, the embodiment 4 is able to calculate an optimal route reflecting the user's intention.

### Embodiment 5

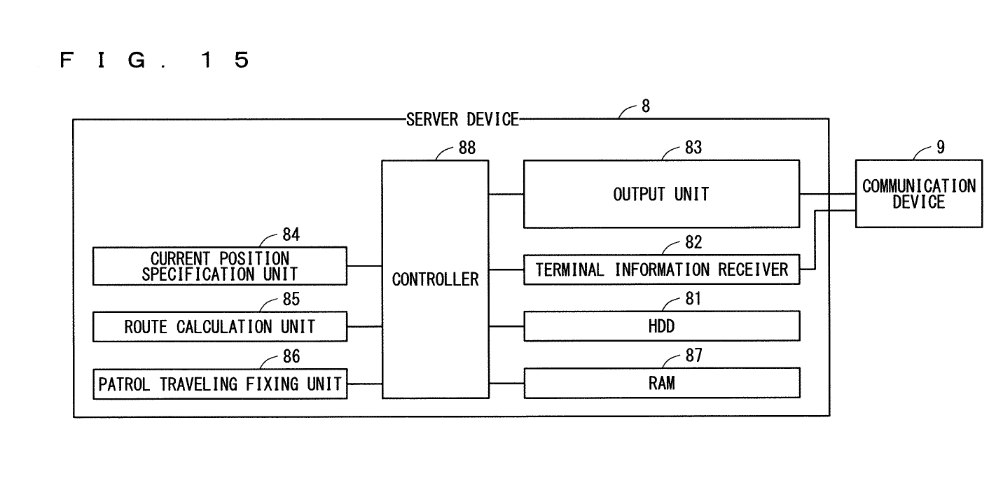

FIG. 15 is a block diagram showing a configuration of a server device 8 according to an embodiment 5 of the present invention.

As shown in FIG. 15, the server device 8 of the embodiment 5 includes: a Hard Disk Drive (HDD) 81 (map information storage means) that stores map information therein; a terminal information receiver 82 that receives various information (terminal-related information) from an external terminal (for example, moving terminal); a current position specification unit 84 (current position specification means) that, based on a current position of the external terminal which is obtained from the information received by the terminal information receiver 82 and the map information stored in the HDD 81, calculate and identify the location on a road in a map where the current position is most likely to exist; a route calculation unit 85 (route calculation means) that calculates an optimal route from the current position to a predetermined site or an optimal route between predetermined sites; an output unit 83 (output means) that outputs the optimal route calculated by the route calculation unit 85 to the external terminal; a RAM 87; and a controller 88 that totally controls operations of elements of the server device 8.

A communication device 9 for transmitting information given from the output unit 83 to the external terminal is connected to the server device 8.

Each element of the server device 8 achieves its own function by reading and writing necessary information from and to the RAM 87.

The information received by the terminal information receiver 82 includes information (sensor information) supplied from a vehicle speed sensor which is connected to an external terminal and measures the speed of movement of the terminal, a GPS receiving antenna that receives a signal from a GPS satellite, and an angular velocity sensor that measures a change in the direction of the external terminal. The information also includes a search condition inputted to the external terminal by the operation performed by the user, and the state of a via point (whether it is an indispensable via point or a dispensable via point). In other words, the terminal information receiver 82 (terminal information receiving means) receives information (predetermined site information) that designates a via point as an indispensable via point at which stopping is indispensable or a dispensable via point at which stopping is not indispensable.

The current position specification unit 84 identifies the current position of the external terminal based on the information that the terminal information receiver 82 has obtained from the vehicle speed sensor, the angular velocity sensor, and the GPS receiving antenna, and also calculates the location on a map where the external terminal is most likely to exist based on the map information stored in the HDD 81.

The map information stored in the HDD 81 is expressed in a graph structure in which an intersection is represented by a node and a road between intersections is represented by a link. For each link, information including cost information necessary for passing through a road corresponding to the link, a travel distance for the link, whether or not it is a toll road, and the like, is set.

By using the cost information set for each link included in the map information, the route calculation unit 85 calculates, as the optimal route, a route that provides the minimum accumulated cost by means of a known search method (for example, Dijkstra's algorithm).

For calculating the optimal route in each section, the route calculation unit 116 can select a condition received by the terminal information receiver 82 from a plurality of predetermined search conditions prepared in advance, and adjust the cost for each link based on the selected search condition. For example, three search conditions of “recommended mode”, “toll-road avoiding mode”, and “distance priority mode” are prepared. In a case where the “recommended mode” is selected, only the cost information set for the link is used to calculate the optimal route. In a case where the “toll-road avoiding mode” is selected, the optimal route is calculated with a predetermined penalty cost being added to the cost information of the link for which a toll road is set, based on the information set for the link indicating whether or not the road is a toll road. In a case where the “distance priority mode” is selected, the optimal route is calculated based on the travel distance for the link instead of the cost information.

The selected search condition may be applied to the entire route or applied to each section.

Thus, the route calculation unit 85 (route calculation means) is configured such that, in re-calculation of the new route, in a case where a section included in the current route (existing route) is also included in the new route, the predetermined calculation condition applied to the section of the current route is also applied to the corresponding section of the new route, and in a case where a section included in the current route is not included in the new route, a predetermined calculation condition that has been specified in advance is applied to the section of the new route.

In the server device 8 of the embodiment 5, the terminal information receiver 82 receives information of the destination that the user has newly set, and then the same operations as the operations shown in FIGS. 3, 4, and 8 of the embodiment 1 are performed. In the server device 8 of the embodiment 5, the terminal information receiver 82 receives information of the via point that the user has newly set, and then the same operations (see FIG. 11) as those of the embodiment 3 are performed. Therefore, in a case of receiving new predetermined site information and re-calculating a new route under a situation that the current route (existing route) to the destination (existing destination) has been already calculated, the route calculation unit 85 applies the predetermined condition that was set for the calculation of the current route to the re-calculation of the new route, too. A traveling order fixing unit 86 (traveling order fixing means) is also provided that fixes the absolute traveling order of traveling a predetermined via point and the destination among the destination and via points (existing via points) included in the current route. The route calculation unit 85 applies the traveling order fixed by the traveling order fixing unit 86, as the predetermined condition, to the re-calculation of the new route. In re-calculating the new route, the route calculation unit 85 does not use a dispensable via point based on the information received by the terminal information receiver 82.

In a modification of the server device 8 of the embodiment 5, the same operations (see FIGS. 10 and 13) as those of the embodiments 2 and 4 may be performed. In such a case, a relative traveling order fixing unit (not shown) instead of the traveling order fixing unit 86 may be provided in the server device 8. That is, a relative traveling order fixing unit (relative traveling order fixing means) is provided that fixes a relative traveling order of traveling a predetermined via point and the destination among the destination (existing destination) and the via points (existing via points) included in the current route (existing route), and the route calculation unit (route calculation means) applies the traveling order fixed by the relative traveling order fixing unit, as the predetermined condition, to the re-calculation of the new route.

In the embodiment 5, therefore, in a case where, under a situation that a new site (new destination and via points) is added after a route to the destination is set by the external terminal, the user intends to designate the order of traveling a part of the via points and destination (the existing via point and destination) included in the current route, optimization of the route is enabled in the server device with reflection of such an intention. Moreover, a search condition that the user has set for the calculation of the current route can be taken over in the calculation of the new route. Thus, the embodiment 5 is able to calculate an optimal route reflecting the user's intention.

In the embodiment 5, the server device 8 including the current position specification unit 84 calculates the current position of the external terminal based on various sensor information received from this terminal. Here, the same effects as those of the embodiment 5 are exerted by a configuration in which the current position of the external terminal is specified by the terminal itself while the terminal information receiver 82 of the server device 8 receives information of the current position calculated by the terminal itself so that the server device 8 performs only the calculation of the route. Thus, the server device includes: a terminal information receiver (terminal information receiving means) that receives terminal-related information including information of the current position of the external terminal and predetermined site information containing the destination and the via point set by the terminal; a route calculation unit (route calculation means) that calculates a route from the current position received by the terminal information receiver to a predetermined site; and an output unit (output means) that outputs the route calculated by the route calculation unit to the terminal. In a case of receiving a new predetermined site (a destination or a via point) and re-calculating a new route under a situation that the current route (existing route) to the destination (existing destination) has been already calculated, the route calculation unit applies the predetermined condition that was set for the calculation of the current route to the re-calculation of the new route, too.

In the present invention, within the scope thereof, the embodiments may be freely combined with one another, and the embodiments may be appropriately varied, modified, or omitted.

### DESCRIPTION OF THE REFERENCE SIGNS

1 car navigation device; 2 display device; 3 sound output device; 4 remote-controller light receiving device; 5 vehicle speed sensor; 6 GPS receiving antenna; 7 angular velocity sensor; 8 server device; 9 communication device; 81 HDD; 82 terminal information receiver; 83 output unit; 84 current position specification unit; 85 route calculation unit; 86 traveling order fixing unit; 87 RAM; 88 controller; 111 HDD; 112 sensor information input unit; 113 user operation input unit; 114 output unit; 115 current position spacification unit; 116 route calculation unit; 117 route guide unit; 118 map display; 119 traveling order fixing unit; 120 route calculation condition input unit; 121 RAM; 122 controller; and 123 relative traveling order fixing unit.

1-16. (canceled)

17. A navigation device comprising:
a map information storage that stores map information;
a sensor information input unit that inputs sensor information from at least one sensor, for identification of a current position of the navigation device;
a current position specification unit that specifies said current position of the navigation device on a map based on said map information stored in said map information storage and said sensor information inputted to said sensor information input unit;
a site input unit that inputs a predetermined site including a destination or a via point; and
a route calculation unit that calculates a route from said current position specified by said current position specification unit to said predetermined site inputted to said site input unit,
said route calculation unit being configured such that, in a case where said predetermined site is newly designated and said route calculation unit needs to re-calculate a new route under a situation that an existing route to an existing destination has been already calculated, and in a case where a section that is divided by via points included in said existing route is also included in said new route, a predetermined calculation condition at a time of route calculation is also applied to said section of said new route, said predetermined calculation condition being applied to said section of said existing route, so that the calculation is performed in consideration of a change in a traveling order of traveling said existing destination or an existing via point included in said existing route.

18. The navigation device according to claim 17, further comprising
a traveling order fixing unit that fixes an absolute traveling order of traveling a predetermined existing via point or said existing destination among said existing destination or said existing via points included in said existing route, wherein
said route calculation unit applies said traveling order fixed by said traveling order fixing unit to said re-calculation of said new route.

19. The navigation device according to claim 17, further comprising
a relative traveling order fixing unit that fixes a relative traveling order of traveling a predetermined existing via point or said existing destination among said existing destination or said existing via points included in said existing route, wherein
said route calculation unit applies said traveling order fixed by said relative traveling order fixing unit to said re-calculation of said new route.

20. The navigation device according to claim 17, further comprising
a route calculation condition input unit that inputs said predetermined calculation condition, said predetermined calculation condition being applied to an entire route from a current location to a destination or applied to each of sections divided by via points of said route, wherein
in a case where said section included in said existing route is not included in said new route at a time of said re-calculation of said new route, said route calculation unit applies said predetermined calculation condition that has been specified in advance to said section of said new route.

21. The navigation device according to claim 17, wherein
in a case where said existing route includes a section that is divided at the same via points as the via points dividing a section included in said new route and that has a traveling order direction inverted from the traveling order direction of the corresponding section of the new route, said route calculation unit applies, to this section, the same predetermined calculation condition as the predetermined calculation condition used for the calculation of said existing route.

22. The navigation device according to claim 17, wherein
said site input unit designates said via point inputted thereto as an indispensable via point that is a via point at which stopping is indispensable or a dispensable via point that is a via point at which stopping is not indispensable,
at a time of said re-calculation of said new route, said route calculation unit does not use said dispensable via point designated by said site input unit.

23. The navigation device according to claim 22, wherein
in a case where said existing route includes the same section as a section divided at said indispensable via points at a time of said re-calculation of said new route, said route calculation unit uses said dispensable via point included in this section.

24. The navigation device according to claim 23, wherein
in a case where said existing route includes a section that is the same as a section divided at said indispensable via points and that has a traveling order direction inverted, said route calculation unit calculates a route while applying, to this section, a traveling order whose direction is inverted from the direction of the traveling order of said existing route.

25. The navigation device according to claim 17, further comprising
an output unit that outputs said route calculated by said route calculation unit, wherein
in a case where said new route calculated by said route calculation unit has a traveling order different from that of said existing route, said output unit outputs a notification that the traveling order is different.

26. The navigation device according to claim 25, further comprising
a route selection unit that, when said output unit outputs said notification that the traveling order is different, present a selectable option of whether the traveling order in said existing route or the traveling order in said new route is to be applied to said re-calculation of said new route.

27. A server device comprising:
a map information storage that stores map information;
a terminal information receive that receives terminal-related information relating to an external terminal, said terminal-related information including sensor information for specification of a current position of said terminal obtained by said terminal and predetermined site information including a destination or a via point set by said terminal;
a current position specification unit that specifies a current position of said terminal on a map based on said map information stored in said map information storage and said sensor information received by said terminal information receiver;
a route calculation unit that calculates a route from said current position specified by said current position specification unit to said predetermined site received by said terminal information receiver; and
an output unit that outputs, to said terminal, said route calculated by said route calculation unit,
said route calculation unit being configured such that, in a case where said predetermined site information is newly received and said route calculation unit needs to re-calculate a new route under a situation that an existing route to an existing destination has been already calculated, and in a case where a section that is divided by via points included in said existing route is also included in said new route, a predetermined calculation condition at a time of route calculation is also applied to said section of said new route, said predetermined calculation condition being applied to said section of said existing route, so that the calculation is performed in consideration of a change in a traveling order of traveling said existing destination or an existing via point included in said existing route.

28. The server device according to claim 27, further comprising
a traveling order fixing unit that fixes an absolute traveling order of traveling a predetermined existing via point or said existing destination among said existing destination or said existing via points included in said existing route, wherein
said route calculation unit applies said traveling order fixed by said traveling order fixing unit to said re-calculation of said new route.

29. The server device according to claim 27, further comprising
a relative traveling order fixing unit that fixes a relative traveling order of traveling a predetermined existing via point or said existing destination among said existing destination or said existing via points included in said existing route, wherein
said route calculation unit applies said traveling order fixed by said relative traveling order fixing unit to said re-calculation of said new route.

30. The server device according to claim 27, wherein
in a case where said section included in said existing route is not included in said new route at a time of said re-calculation of said new route, said route calculation unit applies said predetermined calculation condition that has been specified in advance to said section of said new route.

31. The server device according to claim 27, wherein
said terminal information receiver receives information that designates said via point as an indispensable via point that is a via point at which stopping is indispensable or a dispensable via point that is a via point at which stopping is not indispensable,
at a time of said re-calculation of said new route, said route calculation unit does not use said dispensable via point based on the information received by said terminal information receiver.

32. A server device comprising:
a terminal information receiver that receives terminal-related information relating to an external terminal, said terminal-related information including information of a current position of said terminal and predetermined site information including a destination or a via point set by said terminal;
a route calculation unit that calculates a route from said current position to said predetermined site that are received by said terminal information receiver; and
an output unit that outputs, to said terminal, said route calculated by said route calculation unit,
said route calculation unit being configured such that, in a case where said predetermined site is newly received and said route calculation unit needs to re-calculate a new route under a situation that an existing route to an existing destination has been already calculated, and in a case where a section that is divided by via points included in said existing route is also included in said new route, a predetermined calculation condition at a time of route calculation is also applied to said section of said new route, said predetermined calculation condition being applied to said section of said existing route, so that the calculation is performed in consideration of a change in a traveling order of traveling said existing destination or an existing via point included in said existing route.

33. The server device according to claim 32, further comprising
a traveling order fixing unit that fixes an absolute traveling order of traveling a predetermined existing via point or said existing destination among said existing destination or said existing via points included in said existing route, wherein
said route calculation unit applies said traveling order fixed by said traveling order fixing unit to said re-calculation of said new route.

34. The server device according to claim 32, further comprising
a relative traveling order fixing unit that fixes a relative traveling order of traveling a predetermined existing via point or said existing destination among said existing destination or said existing via points included in said existing route, wherein
said route calculation unit applies said traveling order fixed by said relative traveling order fixing unit to said re-calculation of said new route.

35. The server device according to claim 32, wherein
in a case where said section included in said existing route is not included in said new route at a time of said re-calculation of said new route, said route calculation unit applies said predetermined calculation condition that has been specified in advance to said section of said new route.

36. The server device according to claim 32, wherein
said terminal information receiver receives information that designates said via point as an indispensable via point that is a via point at which stopping is indispensable or a dispensable via point that is a via point at which stopping is not indispensable,
at a time of said re-calculation of said new route, said route calculation unit does not use said dispensable via point based on the information received by said terminal information receiver.
